(19) United States
(12) Patent Application Publication
(10) Pub. No.: US 2024/0092610 A1
(43) Pub. Date: Mar. 21, 2024

(54) METHOD AND CONTROLLER FOR DETERMINING INFORMATION ABOUT A CURRENT LOCATION OF A CAR IN A SHAFT OF AN ELEVATOR

(71) Applicant: Inventio AG, Hergiswil (CH)

(72) Inventor: Valerio Villa, Colverde (IT)

(21) Appl. No.: 18/256,642

(22) PCT Filed: Dec. 15, 2021
(86) PCT No.: PCT/EP2021/085960

§ 371 Date: Jun. 9, 2023

(30) Foreign Application Priority Data
Dec. 16, 2020 (EP) 20214661.9

(51) Int. Cl. B66B 1/34

(52) U.S. Cl. CPC B66B 1/3492

(57) ABSTRACT

A method and a controller determine information about a current location of a car in a shaft of an elevator. The method includes the steps of: measuring a distance between a car reference position at the car and a shaft reference position in the shaft using a laser distance measuring device; analyzing a plausibility of the measured distance taking into account plausibility information correlating with the current location of the car independently from the distance measuring; and determining the information about the current location of the car based on the measured distance and the analyzed plausibility.

### FIELD

The present invention relates to a method for determining information about a current location of a car in a shaft of an elevator. Furthermore, the invention relates to a controller configured for implementing such method and to an elevator comprising such controller.

### BACKGROUND

In elevators, a car is generally displaced along a shaft for approaching various floors at different levels throughout a building. In order to implement safety measures and/or in order to implement functionalities such as precisely displacing the car throughout the shaft and stopping the travelling car precisely at an intended level, a current location of the car in the shaft has to be known. The information about the current location of the car may for example be used by an elevator controller controlling a drive engine, a braking mechanism and/or other functionalities within the elevator.

There are various conventional methods and techniques for determining information about the current location of the car in the shaft. Typically, such methods and techniques have to fulfil strict safety requirements in order to provide the location information with high reliability.

EP 2 516 304 B1 discloses a floor position detection device of an elevator system. Therein, Hall sensors are used for detecting magnetic markers positioned at different locations throughout the elevator shaft. While such approach for determining information about the location of the car based on locally detecting one or more of a multiplicity of distributed magnetic markers may provide for a precise and reliable position detection, it generally requires complex hardware. Accordingly, fabrication, installation and/or maintenance of the position detection device may be laborious and expensive.

GB 2211046 A discloses a device for monitoring the movement of a car in a shaft. Therein, a laser transmitter is positioned at one end of the shaft so as to transmit a laser beam along a length of the shaft. A reflector is mounted on the car so as to reflect the laser beam back to a receiver positioned adjacent to the transmitter. An output of the receiver is monitored to determine the position of the car in the shaft and the velocity of the car relative to the shaft.

However, it has been found that such laser-based monitoring of the current position of the car may be subject to various disturbing influences or errors such that a reliability of such approach may be insufficient for some safety-critical applications.

### SUMMARY

There may be a need for a method for determining information about a current location of a car in a shaft of an elevator, the method requiring relatively simple hardware and/or hardware being easy to install and/or to maintain, while providing for a sufficient reliability of determined position information. Additionally, there may be a need for a method for operating an elevator in which the car location is determined in the indicated manner. Furthermore, there may be a need for a controller for implementing such method and for an elevator comprising such controller.

Such needs may be met with the subject-matter of the advantageous embodiments defined in the following specification and in the figures.

According to a first aspect of the present invention, a method for determining information about a current location of a car in a shaft of an elevator is proposed. The method comprises at least the following steps, preferably in the indicated order: measuring a distance between a car reference position at the car and a shaft reference position in the shaft using a laser distance measuring device,
analyzing a plausibility of the measured distance taking into account plausibility information correlating with the current location of the car independently from the distance measuring, and
determining the information about the current location of the car based on the measured distance and the analyzed plausibility.

According to a second aspect of the invention, a method for operating an elevator is proposed. Therein, functions of the elevator are controlled based on information about a current location of a car in a shaft of the elevator determined with a method according an embodiment of the first aspect of the invention.

According to a third aspect of the invention, a controller for determining information about a current location of a car in a shaft of an elevator is proposed, wherein the controller is configured for implementing and/or controlling a method according to an embodiment of the first aspect of the invention.

According to a fourth aspect of the invention, an elevator is proposed, the elevator comprising, inter-alia, a car, a shaft, a laser distance measuring device for measuring a distance between a car reference position at the car and a shaft reference position at the shaft and further comprising a controller according to an embodiment of the third aspect of the invention.

Ideas underlying embodiments of the present invention may be interpreted as being based, inter alia, on the following observations and recognitions.

As already briefly indicated further above, techniques have been developed for detecting the current location of a car in an elevator shaft. In order to enable using the determined location information for safety critical applications, such techniques have to be reliable. For example, such techniques have to comply with an elevated safety integrity level such as e.g. an SIL2 or even SIL3. Accordingly, conventional car location determination techniques in elevators are generally complex and expensive.

Briefly summarized, the approach described herein seeks to use a simple and relatively cheap technique for determining the current car location in the elevator shaft and to significantly increase a reliability of such technique by specifically checking the results provided by such technique for their plausibility. Specifically, a laser distance measuring device shall be applied for measuring a distance between a fixed reference position in the elevator shaft and another reference position at the car. Therein, it is important that the analysis of the plausibility of measurement results provided by the laser distance measuring device is based on data which, on the one hand, correlate with the current location of the car in the elevator shaft but which, on the other hand, are independent from the measurements actually applied for detecting the car location using the laser distance measuring device. Preferably, the result of the measured distance may be analyzed for its plausibility using data sources which are already accessible in the elevator arrangement. For example, sensors included in the elevator arrangement for other purposes may provide information which may be used for analyzing the plausibility of the measured distance. Finally, by determining the information about the current location of the elevator car based on both, the distance measured by the laser distance measuring device as well as the analyzed plausibility, the acquired overall location information may be provided with a substantially higher reliability than it is the case when only measurements of the laser distance measuring device would be used without analyzing their plausibility. Accordingly, with the approach described herein, car location determination may be implemented with relatively simple and cheap hardware and, as the determination results may be provided with an increased reliability, the provided car location information may be used even upon increased safety and reliability requirements. Particularly, the proposed approach generally requires few or no additional hardware for increasing the reliability of the measurement results of the laser distance measuring device, as hardware for providing suitable plausibility information correlating with the current location of the car is generally accessible in elevator arrangements, anyway.

In the following, possible embodiments of the approach proposed herein shall be described in more detail.

The laser distance measuring device applied for measuring the distance between the car reference position and the shaft reference position may be a device which emits a laser beam towards an object and detects portions of the laser beam upon being reflected at the object in order to then measure a distance of the object based on analyzing the detected laser beam portions. For example, the laser distance measuring device may use a time-of-flight (TOF) technique for measuring the distance of the object. Therein, a measured duration between emitting laser light and receiving reflected portions of the laser light be used for calculating the distance of the reflecting object. Optionally, a phase shift in oscillations phases between the emitted laser light and the received laser light may be used for determining the time-of-flight.

The laser distance measuring device may comprise a laser source for emitting the laser beam, a light detector for detecting the reflected laser beam light and a processing unit for analyzing the signals provided by the light detector. The laser distance measuring device may be a conventional, commercially available device of relatively simple construction and/or high robustness. The laser source may emit any kind of laser beam such as a laser beam in the visible spectrum or an invisible laser beam for example in the infrared spectrum. The laser source may emit a continuous laser beam (cw laser) or a pulsed laser beam with pulse lengths being for example adapted for the distance measurement purposes. The light detector may be configured for detecting portions of the emitted laser beam upon being reflected at a distant object and to provide signals to the processing unit for analyzing such laser beam portions. The processing unit may then determine for example the time-of-flight in order to finally calculate the distance of the reflecting object.

The laser distance measuring device is applied for measuring a distance between a first position at the displaceable elevator car and a second position being stationary within the elevator shaft. The first position is referred to herein as car reference position and may coincide with any location or installation provided at a fixed position at the elevator car such that the car reference position unambiguously correlates with a position of the car within the elevator shaft. The second position is referred to herein as shaft reference position and is a stationary position fixedly provided within the elevator shaft, for example at a top or at a bottom of the elevator shaft. For example, the laser distance measuring device may be installed at the shaft reference position and a laser beam reflector may be installed at the car reference position, or vice versa. Accordingly, by measuring the distance between the laser distance measuring device and the laser beam reflector, an unambiguous information about the elevator car within the elevator shaft may be acquired.

However, it has been found that determining the location of the car exclusively based on the measurements provided by the laser distance measuring device may be subject to various influences and disturbances. For example, over time and/or due to mechanical forces acting onto components, the laser distance measuring device and/or the laser beam reflector may be displaced from their original car and shaft reference positions and/or installation orientations, resulting in the measured distance no more precisely representing the current car position in the elevator shaft. Furthermore, depositions of the dust or dirt on the laser distance measuring device and/or the laser beam reflector may deteriorate laser beam detections. In worst cases, a direct view between the laser distance measuring device and the laser beam reflector may be obstructed for example by foreign objects within the elevator shaft such that, instead of a distance to the laser beam reflector, a distance to such obstructing foreign object is erroneously measured. Similarly, a position and/or an installation orientation of the laser distance measuring device and/or of the laser beam reflector may be changed excessively such that the laser distance measuring device does no more detect laser beam portions reflected by the laser beam reflector but may detect laser light reflected at other objects and therefore measures a distance to such object instead of the distance to the laser beam reflector.

Generally, in conventional approaches, it was not possible to reliably detect whether or not the distance measurement results provided by the laser distance measuring device are reliable or not. Particularly, as long as the laser distance measuring device provided any signals, it was not possible to determine whether these signals result from detecting laser beam portions reflected at the laser beam reflector upon both, the laser distance measuring device and the laser beam reflector being correctly positioned or whether such signals result from a disturbed or erroneous measurement.

In order to overcome such deficiency, it is proposed to acquire further information which allows analyzing the plausibility of the measured distance as provided by the laser distance measuring device. Such further information is referred to herein as plausibility information. As described in more detail further below, various types of plausibility information may be acquired and used for the plausibility analysis. Therein, it is important that the plausibility information correlates with the current location of the car in the elevator shaft, i.e. the plausibility information is represented by data which unambiguously vary depending on the current location of the car. Furthermore, it is important that the plausibility information is acquired independently from the distance measuring. This means that effects or disturbances influencing the distance measuring procedure executed by the laser distance measuring device shall not effect or at least not effect in a same way the plausibility information. Accordingly, in cases where the distance measurement of the laser distance measuring device is disturbed, a relation between the results of the distance measurement and the plausibility information will change in a detectable manner.

Accordingly, by taking into account not only the distance measured by the laser distance measuring device but additionally taking into account the analyzed plausibility information, the information about the current location of the car may be determined with a significantly higher reliability. This may be particularly true as disturbances or errors in the distance measurement procedure may be recognized upon comparison with the analyzed plausibility information.

For example, in cases where the analysis of the plausibility of the measured distance indicates that the measured distance appears to be plausible and therefore reliable, the information about the current location of the car may be marked as being reliable. In other words, the information about the current location of the car may not only comprise the actual location data indicating the position of the car in the elevator shaft as measured by the laser distance measuring device but may additionally comprise reliability data indicating a reliability of such location data. For example, the reliability data may indicate that the distance measured by the laser distance measuring device is plausible within tight tolerances, is plausible within acceptable tolerances, is not plausible within acceptable tolerances but is only slightly outside a tolerance range or is not plausible at all. Accordingly, for example other components of the elevator such as an elevator controller subsequently using these location data of the car location information may decide whether these data fulfil reliability requirements based on the additionally provided reliability data.

According to an embodiment, there are situations during an operation of the elevator in which the laser distance measuring device is temporarily deactivated. In such circumstances, upon executing the method described herein, the distance shall be measured and the plausibility shall be analyzed after reactivating the laser distance measuring device after such preceding temporary deactivation.

It has been found that it may be advantageous to temporarily actively deactivate the laser distance measuring device under certain conditions. Thereby, for example an energy consumption caused by the laser distance measuring device may be reduced. Furthermore, it has been observed that the laser distance measuring device may be subject to unintended temporary deactivation for example in cases of a power supply interruption, blackout or similar events. As a further alternative, the entire elevator arrangement may be temporarily stopped or shut down for example due to a detection of a safety critical malfunction or in order to perform maintenance works. The deactivation of the laser distance measuring device may last for some seconds (e.g. more than 10 s), some minutes (e.g. more than 10 min), some hours (e.g. more than 1 h) or even some days (e.g. more than 1 day).

It has been found that particularly during periods of such deactivation, the elevator arrangement and particularly its laser distance measuring device may be prone to changes and modifications which may result in a determination of the current car location information being erroneous or at least no more sufficiently reliable. For example, during a temporary deactivation, components of the laser distance measuring device or the laser beam reflector may be slightly displaced in their positions relative to the intended car reference position and shaft reference position, respectively. As another example, such components may be damaged or the laser beam reflector may even be unintendedly destroyed e.g. during maintenance works.

While such changes and modifications in the laser distance measuring device might be detectable during normal operation of the device, for example due to sudden changes in signals provided by such device, the changes and modifications may remain undetected during periods of temporary deactivation of the device. Accordingly, it is suggested to specifically measure the distance between the car reference position and the shaft reference position using the laser distance measuring device as soon as possible after the laser distance measuring device is reactivated and to then timely also analyze the plausibility of such measured distance. For example, such distance measuring and plausibility analyzing procedure may be performed when or shortly before normal operation of the elevator and its laser distance measuring device is resumed. As an example, such procedure may be performed within less than one minute, preferably less than ten seconds, after reactivating the laser distance measuring device.

In a further specified embodiment, the laser distance measuring device is temporarily deactivated when the car is stopped within the shaft and the laser distance measuring device is reactivated when the car is started to be displaced within the shaft.

For example, the laser distance measuring device may be deactivated as long as the car is stopped at one of the floors. In such situation, the car is generally not allowed to significantly move within the shaft and, accordingly, the current location of the car may be assumed to be stationary such that there may be no need to repeatedly measure this current location and associated energy consumption may be saved. When the car is started to be displaced again within the shaft, the laser distance measuring device may be reactivated such that the current location of the travelling car may be measured continuously or repeatedly. Upon such reactivation, the distance indicating the current car location is measured and its plausibility is analyzed. This may be done coincidentally with starting the displacement of the car or, preferably, shortly before starting such displacement. Under certain circumstances such as fulfilling predefined safety requirements, such distance measurement and plausibility analysis may also be performed shortly after starting the displacement, for example within a sufficiently short duration before a car velocity exceeds an acceptable predetermined limit.

In the following, various options of plausibility information and analyzing such plausibility information will be described. The plausibility analysis may be implemented based on each of such options or based on a combination of some or all of these options.

According to an embodiment, the plausibility is analyzed while the car is stopped at a landing. Therein, the plausibility information is derived from signals of location sensors which determine a precise location of the car when being stopped at the landing.

Generally, while the elevator car is stopped at a landing, i.e. at one of the floors in a building such that passengers may enter and exit the car, provisions are accessible which allow precisely determining the current location of the car. Particularly, elevator arrangements generally comprise location sensors which allow precisely determining the location of the car as long as the car waits at a landing. Such location sensors are typically provided as a precise positioning of the car is particularly relevant during such stopping periods, as for example the car shall stop at a landing position such that its car bottom is substantially flush with a bottom at the adjacent floor in order to prevent any dangerous steps. Accordingly, signals from such location sensors may serve as an additional source of information which may be used in the approach proposed herein as plausibility information.

Specifically, in accordance with an embodiment, the plausibility information may be derived from location signals of a door sensor provided at a car door and/or at a landing door, such door sensor being configured for sensing a presence of a counterpart upon the car being positioned at a predetermined location within the shaft.

Generally, an elevator arrangement comprises a car door which is provided at and displaced together with the elevator car. Furthermore, the elevator arrangement comprises multiple landing doors fixedly installed in the elevator shaft at each of the landings in a building. Typically, each of these doors is provided with a door sensor. Such door sensor may detect the presence of a counterpart. Such counterpart may be another sensor or a marker. For the door sensor at the car door, such counterpart may be provided at a fixed location within the elevator shaft such that the car's door sensor may detect when the elevator car reached a specific location within the elevator shaft. For example, this location may be set such that the car door is arranged directly opposite to a landing door and is levelled with the landing door upon the car being stopped at a landing position. Similarly, for the door sensor at one of the landing doors, the counterpart may be provided at the elevator car. Accordingly, such landing door sensor may signalize that the elevator car reached a predefined position at or close to the landing door.

As such door sensors are generally provided at the car door and the landing doors of an elevator arrangement for other purposes, anyway, signals provided by such door sensors may be used as plausibility information in the method proposed herein, while requiring no or hardly any additional hardware to be installed within the elevator arrangement.

According to an embodiment, the plausibility may be analyzed while the car is displaced throughout the shaft. Therein, the plausibility information may be derived from acceleration signals of an acceleration sensor which determine an acceleration of the car.

Generally, in modern elevator arrangements, the elevator car is provided with one or more acceleration sensors. Therein, the acceleration sensor may measure the acceleration acting onto the car upon being vertically displaced throughout the elevator shaft. The acceleration sensor may measure accelerations in one, two or three dimensions. Accordingly, based on signals from the acceleration sensor, an actual displacement of the elevator car, an actual velocity of the elevator car and/or an actual acceleration of the elevator car may be derived. Corresponding data may also be derived from the distance measurement executed by the laser distance measuring device. Accordingly, the acceleration signals provided by the acceleration sensor may be used as plausibility information for example by comparing the values of the actual car displacement, actual car velocity and/or actual car acceleration as derived from the acceleration signals with those corresponding values as derived from the distance measurement of the laser distance measuring device.

As one or more acceleration sensors are generally provided at the car of an elevator arrangement for other purposes, anyway, signals provided by such acceleration sensors may be used as plausibility information in the method proposed herein, while requiring no or hardly any additional hardware to be installed within the elevator arrangement.

According to an embodiment, the plausibility information may be derived from encoder signals of an encoder sensor which determine an orientation of a drive disk of a drive engine applied for displacing the car throughout the shaft.

In an elevator arrangement, the elevator car is typically suspended using rope-like or belt-like suspension-traction means. The suspension-traction means are arranged along a circumference of the drive disk of the drive engine. For displacing the car, the drive disk is rotated by the drive engine thereby displacing the suspension-traction means and the car suspended thereon.

Generally, the drive engine comprises an encoder sensor which is configured for determining a current orientation of the drive disk. Accordingly, upon displacing the car throughout the elevator shaft, the drive disk is continuously rotated and the encoder sensor provides encoder signals which continuously or repeatedly represent the orientation of the rotating drive disk. As the rotating drive disk engages with the suspension-traction means, the encoder signals correlate with the current location of the car suspended by these suspension-traction means. Accordingly, the encoder signals comprise information which may be used as plausibility information in the method described herein.

In elevator arrangements, for example toothed belts or other surface textured suspension-traction means may be applied and cooperate with the circumferential surface of the drive disk in a positive-fitting manner, thereby preventing any slippage between the suspension-traction means and the rotating drive disk. In elevators where the suspension-traction means are configured such that no slippage occurs between the suspension-traction means and the rotating drive disk, each location of the car within the elevator shaft generally unambiguously corresponds to one single orientation of the drive disk. In other words, each time when the elevator car is at a specific position within the elevator shaft, the drive disk of the drive engine has to be in the same orientation and therefore the encoder signal is always the same for such car position.

In such configuration, according to a further specified embodiment, an unambiguous correlation information between each of multiple locations of the car throughout the shaft and associated encoder signals may be acquired in a learning procedure. Then, the plausibility information may be derived from the encoder signals using the unambiguous correlation information.

In other words, the fact that in certain types of elevators, no slippage occurs between the suspension-traction means and the drive disk and that therefore the orientation of the drive disk as detected by the encoder sensor unambiguously correlates with the current location of the elevator car may be used to first learn, for each possible location of the elevator car throughout the shaft, the associated unambiguous encoder signal during a learning procedure. Such learning procedure may comprise e.g. displacing the elevator car along the entire shaft while the car location is precisely supervised and simultaneously determining encoder signals and storing these encoder signals as being associated to the current car location. Alternatively, the learning procedure may be established in other ways. Accordingly, after such learning procedure, there may be for example a database representing an electronic lookup table or there may be an algorithm. Such database or algorithm may allow to indicate which encoder signals should be provided by the encoder sensor in case the car is positioned at a specific shaft location. Alternatively, vice versa, detecting a specific encoder signal, it may be derived at which of multiple positions throughout the elevator shaft, the elevator car may currently be located. Therein, it has to be taken into account that the encoder signal repeats after each 360° rotation of the drive disk such that a single encoder signal may represent various equidistant car locations along a longer car travelling path.

Having learned the unambiguous correlation information during the learning procedure, this correlation information may then be used as plausibility information during subsequent operation of the elevator. For example, upon a specific distance being measured by the laser distance measuring device and indicating a specific car location in the shaft, it may be checked whether the drive disk orientation associated to this car location is actually represented by the encoder signal provided by the encoder sensor. If this is the case, the measured distance and car location appears to be plausible. However, in case of a mismatch, i.e. when the encoder signal indicates a drive disk orientation which, according to the previously learned correlation information, does not correspond to the car location indicated by the distance measurement of the laser distance measuring device, the latter appears to be non-plausible.

In an alternative configuration of an elevator arrangement, suspension-traction means having no substantial surface texture may be applied and cooperate with the circumferential surface of the drive disk in a non-positive-fitting manner. Accordingly, substantial slippage may occur between the suspension-traction means and the rotating drive disk. As a result of such slippage, the orientation of the drive disk does generally not unambiguously correspond to the current location of the elevator car in the shaft. However, even in such configuration, the encoder signal provided by the encoder sensor may be useful upon checking the plausibility of distance measuring results provided by the laser distance measuring device and may therefore serve as plausibility information.

For example, according to an embodiment, during an operation of the elevator, correlation information including information about the distance between the car reference position and the shaft reference position as measured by the laser distance measuring device and information about a concurrent encoder signal is repeatedly stored in a memory. Accordingly, for example at a later point in time, the plausibility information may be derived by comparing currently acquired correlation information with a latest preceding correlation information read from the memory.

In other words, during normal operation of the elevator, first data provided by the laser distance measuring device and second data provided by the encoder sensor may be continuously or repeatedly collected and stored. Therein, the first data correlate with the current location of the car in the elevator shaft as measured by the laser distance measuring device whereas the second data represent the encoder signal which is provided by the encoder sensor at the same time, i.e. when the car is at this current location. Accordingly, for each point in time, a pair of first and second data values may be acquired and may be stored for example in a database. At a later point in time, the information comprised in such database may then be used for deriving plausibility information allowing analyzing the plausibility of the distance measured by the laser distance measuring device.

For example, upon resuming normal operation after a deactivation period in which the laser distance measuring device was temporarily deactivated, the laser distance measuring device may measure the current distance between the car reference position and the shaft reference position and, simultaneously, the encoder signal provided by the encoder sensor may be acquired. Both pieces of information form a current correlation information. This current correlation information may then be compared with the latest preceding correlation information which has been stored in the memory for example just before entering into the deactivation period. In other words, in such comparison, the results of the distance measurements provided by the laser distance measuring device and the encoder signals simultaneously acquired with such distance measurements at points in time before the deactivation period and after the deactivation period are compared with each other.

In cases where both pieces of correlation information are identical, a high probability may be assumed that the elevator car did not substantially move during the deactivation period and that the distance measurement provided by the laser distance measuring device after the deactivation period is plausible. However, in cases where both pieces of correlation information substantially differ from each other, either the elevator car was displaced during the deactivation period or the laser distance measuring device provides an incorrect distance measurement result after the deactivation period. Generally, as it may be assumed that the laser distance measuring device should not be deactivated as long as the elevator car is intendedly displaced throughout the shaft and, vice versa, the elevator car should not move throughout the shaft as long as the laser distance measuring device is deactivated, it may therefore be assumed that the distance measurement provided by the laser distance measuring device after the deactivation period lacks plausibility in cases where both pieces of correlation information are not identical or at least do not correspond to each other within acceptable tolerances.

As an encoder sensor is generally provided at the drive engine of an elevator arrangement for other purposes, anyway, signals provided by such encoder sensor may be used as plausibility information in the method proposed herein, while requiring no or hardly any additional hardware to be installed within the elevator arrangement.

According to a further embodiment, the plausibility information may be derived from brake signals which determine a current status of a car brake for fixing the car within the shaft.

Generally, the elevator car comprises a car brake with which the car may be fixed at a stationary location within the shaft, for example while waiting at one of the landings. For example, such car brake may engage with a counterpart, such as a guide rail, being fixedly installed in the elevator shaft. The car brake may output brake signals indicating the current status of the car brake, i.e. indicating whether the car brake is activated and fixes the car position or whether the car brake is deactivated, i.e. released.

In the method described herein, such brake signals may serve for deriving plausibility information. For example, if the brake signals indicate that since a preceding distance measurement conducted by the laser distance measuring device, the car brake had been continuously activated such that the car was not able to be displaced since then, such information may be used upon analyzing the plausibility of the measured distance.

For example, according to a further specified embodiment, during an operation of the elevator, distance information including information about the distance between the car reference position and the shaft reference position as measured by the laser distance measuring device is stored in a memory before or upon activating the car brake, and, upon detecting that since storing the distance information the cabin car brake was continuously activated for fixing the car within the shaft, the plausibility information is derived by comparing currently acquired distance information with the distance information read from the memory.

In other words, for example, results of a current distance measurement may be compared with results of a preceding distance measurement. Therein, it is taken into account that the brake signals indicate that the car brake had been activated during the entire period between both distance measurements. Accordingly, if both results match within acceptable tolerances, the current distance measurements may be assumed to be plausible whereas in cases of significant mismatch, lacking plausibility may be assumed.

As a car brake outputting brake signals determining a current status of the car brake is generally provided in an elevator arrangement for other purposes, anyway, the brake signals provided by such car brake may be used as plausibility information in the method proposed herein, while requiring no or hardly any additional hardware to be installed within the elevator arrangement.

According to a further embodiment, the plausibility information is derived from laser quality data from the laser distance measuring device, the laser quality data representing a quality of a laser beam detected by the laser distance measuring device upon measuring the distance.

Typically, a light detector comprised in a laser distance measuring device for detecting reflected portions of an emitted laser beam may not only provide a signal indicating whether or not such reflected portions of the laser beam are detected, but may also provide a signal or data representing a quality of the detected laser beam portions such as for example an intensity of the detected laser beam portions. While such laser quality data may not be necessary for actually determining the distance to be measured by the laser distance measuring device, it may provide valuable additional information which may be used for deriving plausibility information upon executing the method proposed herein.

For example, an intensity of laser beam light reflected at an object and detected by the light detector may substantially vary in dependence of the distance between the laser distance measuring device and the reflecting object. Accordingly, the laser quality data representing such intensity may be used as an additional source of information for analyzing the plausibility of the distance measurement executed by the laser distance measuring device.

Furthermore, the intensity of the laser beam light detected by the light detector may generally significantly vary depending on whether the laser beam is for example reflected by a laser beam reflector having a high reflectivity or whether the laser beam is reflected at a surface having low reflectivity. Accordingly, in cases where for example the laser beam emitter and/or the laser beam reflector are misaligned such that the emitted laser beam is not focused onto the laser beam reflector and/or portions reflected by the laser beam reflector are not directed back to the laser distance measuring device, no portions of the laser beam reflected by the laser beam reflector reach the light detector but, at most, portions of the emitted laser beam which have been reflected by other surfaces within the elevator shaft reach the light detector. As the intensity of light detected by the light detector is generally significantly smaller in such cases of misalignment, the laser quality data may provide a hint that the laser distance measuring device may not function as intended and/or that its measurement results may not be sufficiently reliable.

It is to be noted that the applicant of the present application filed another patent application concurrently, i.e. at the same day, with the present application. This other patent application has the title “Method and controller for evaluating information about a current location of a cabin car in a shaft of an elevator”. The evaluation method described therein comprises measuring a distance between a car reference position at the car and a shaft reference position in the shaft using a laser distance measuring device, acquiring laser quality data from the laser distance measuring device, the laser quality data representing a quality of a laser beam detected by the laser distance measuring device upon measuring the distance, and finally evaluating the information about the current location of the car taking into account the measured distance and the laser quality data. Embodiments and details of the evaluation method described in the other patent application may be applicable or adapted to the method for determining the information about the current car location described herein. Accordingly, the entire content of the other patent application (WO 2022/129206 A1) shall be included herein by reference.

In the embodiments of the method for operating an elevator in accordance with the second aspect of the present invention, various functions of the elevator may be controlled based on the information about the current location of the car in the elevator shaft as determined with the method proposed herein. For example, the displacement of the elevator car within the elevator shaft and/or the stopping of the elevator car at intended locations such as at landings may be controlled based on the information about the current car location. Accordingly, this information may e.g. be provided to and used by an elevator controller controlling a functionality of an elevator drive engine.

Embodiments of the controller according to the third aspect of the present invention may for example comprise one or more interfaces via which the controller may receive signals or data provided by the laser distance measuring device. Furthermore, the controller may comprise one or more interfaces via which it may receive signals or data from other devices such as for example from door sensors, acceleration sensors, encoder sensors, brake sensors, etc. Accordingly, the signals received via such interfaces may be used for deriving plausibility information. Furthermore, the controller may comprise a processing unit for processing both, the signals or data from the laser distance measuring device as well as the signals or data received from other devices for deriving plausibility information, in order to then analyze the plausibility of the measured distance and determine the information about the current location of the car based on the measured distance and the analyzed plausibility. Furthermore, the controller may comprise additional components such as a memory for storing for example distance information and/or correlation information as described above.

Embodiments of the elevator according to the fourth aspect of the present invention comprise an elevator car being displaceable throughout an elevator shaft. Furthermore, the elevator comprises a laser distance measuring device and a controller as described herein. The laser distance measuring device may be attached to the elevator car and a laser beam reflector may be fixedly installed within the elevator shaft, or vice versa. The controller may control one or more functionalities of the elevator and may for example communicate with other components of the elevator such as its drive engine.

It shall be noted that possible features and advantages of embodiments of the invention are described herein partly with respect to a method for determining current car location information, partly with respect to a method for operating an elevator using such information, partly with respect to a controller configured for implementing such method and partly with respect to an elevator comprising such controller. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawing. However, neither the drawing nor the description shall be interpreted as limiting the invention.

### DESCRIPTION OF THE DRAWINGS

FIG. 1 shows an elevator with a controller for implementing a method for determining information about a current location of a car in a shaft in accordance with an embodiment of the present invention.

The FIGURE is only schematic and not to scale. Same reference signs refer to same or similar features.

### DETAILED DESCRIPTION

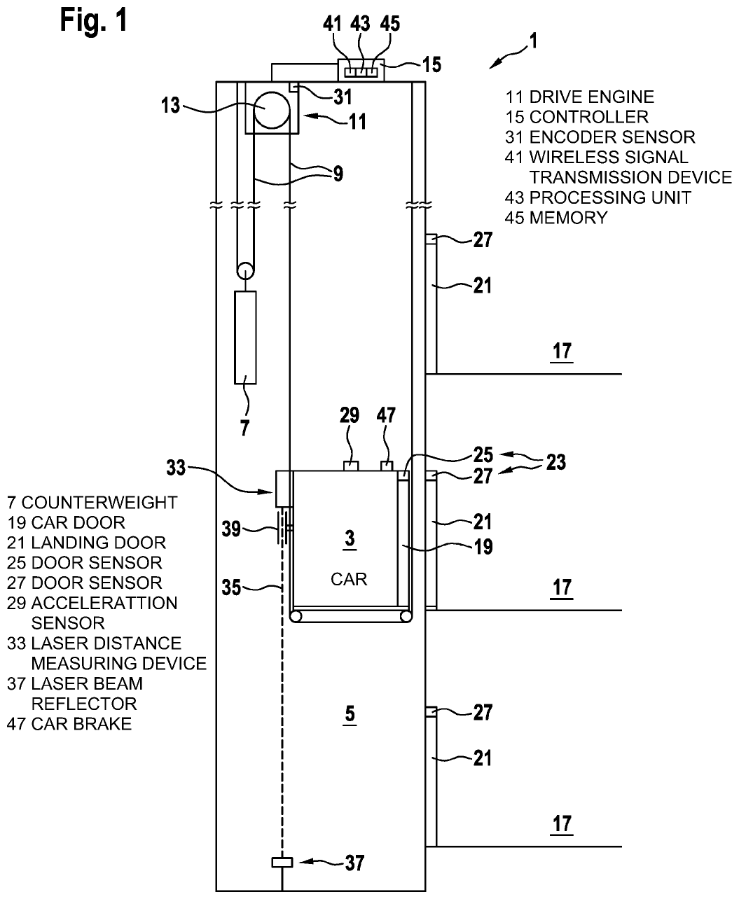

FIG. 1 shows an elevator 1 in which a car 3 may be displaced vertically along a shaft 5. The car 3 and a counterweight 7 are suspended by a suspension traction means 9. The suspension traction means 9 extends along a circumferential surface of a drive disk 13 of a drive engine 11. An operation of the drive engine 11 is controlled by a controller 15. For example, the controller 15 may control the drive engine 11 such that the car 3 may be stopped at one of several landings 17 such that a car door 19 provided at the car 3 is arranged at a position opposite to a landing door 21 provided at the landing 17.

Location sensors 23 may be provided as a door sensor 25 at the car door 19 and as a door sensor 27 at the landing door 21. Such location sensors 23 may determine a precise location of the car 3 when being stopped at one of the landings 17 and may output signals accordingly.

An acceleration sensor 29 is provided at the car 3. Accordingly, the acceleration sensor 29 may sense accelerations acting onto the car 3 and may provide acceleration signals accordingly.

An encoder sensor 31 is provided at the drive engine 11 in order to determine a current orientation of the drive disk 13.

In the elevator 1 described herein, a laser distance measuring device 33 is provided. The laser distance measuring device 33 shall be used in determining information about a current location of the car 3 in the shaft 5.

In the example shown in the FIGURE, the laser distance measuring device 33 is fixed to a side of the car 3 and emits a laser beam 35 in a downward direction. Accordingly, a space occupation above a roof of the car 3 may be minimized to for example allow a no head application. Furthermore, the downwards orientation of the laser distance measuring device 33 may help minimizing a gathering of dust and/or dirt and/or water on lenses of a laser system comprised therein. Furthermore, being below a car roof level, in case a technician works on the roof as a platform, he cannot come into contact with the laser beam 35 inadvertently, both to avoid disturbances for the laser beam 35 as well as to avoid beaming an eye of the technician. The laser beam 35 is directed towards a laser beam reflector 37 installed at or close to a bottom of the shaft 5. The laser beam 35 may be directed to a reflector plate of the laser beam reflector 37, which may be placed such that it is out of a way when the technician is in a pit of the shaft 5, in order to avoid for example interruptions as well as to avoid beaming in the eyes of the technician.

On its path between a laser source included in the laser distance measuring device 33 and the laser beam reflector 37, the laser beam 35 is transmitted and channeled through an opaque pipe 39. The pipe 39 may have a narrow diameter and may be fixed to the structure of the car 3 while being mechanically unlinked from the laser distance measuring device 33, particularly from the laser source comprised therein. Accordingly, the pipe 39 may provide for further protection against pollution and, additionally, may constrain a maximum misalignment that the laser distance measuring device 33 may have upon measuring a distance to the laser beam reflector 37. The opaque pipe isn't essential, so it's also possible to use the laser distance measuring device without the opaque pipe.

In order to determine information about the current location of the car 3 in the shaft 5, a distance between a car reference position at the car 3 and a shaft reference position at the shaft 5 is measured using the laser distance measuring device 33. Furthermore, plausibility information correlating with the current location of the car 3 independently from such distance measuring procedure is acquired. Based on such plausibility information, the distance measured by the laser distance measuring device 33 is analyzed for its plausibility. Finally, the information about the current location of the car 3 is determined based on both, the measured distance as well as the analyzed plausibility.

Particularly, such procedure may be executed after the laser distance measuring device 33 has been temporarily deactivated for example during a stop of the car 3 at one of the landings 17. Accordingly, upon resuming the operation of the laser distance measuring device 33 upon reactivation, the distance between the laser distance measuring device 33 and the laser beam reflector 37 may be measured and the measuring results may be checked for their plausibility in order to thereby significantly increase a reliability of the information about the current location of the car 3 provided thereby. Accordingly, such information may be used e.g. for safety critical functionalities such as controlling an operation of the drive engine 11 for displacing the car 3 throughout the shaft 5.

The plausibility information may be derived from one or more of various sensors and/or data sources which may be provided within the elevator 1 and which may generally serve for other purposes during elevator operation.

For example, the plausibility may be analyzed while the car 3 is stopped at one of the landings 17. In such situation, the plausibility information may be derived from signals of location sensors 23 formed by the car door sensor 25 and/or the landing door sensor 27. As these location sensors 23 may precisely detect the current location of the car 3 when being stopped at the landing 17, the data or signals provided by such location sensors 23 precisely correlate with the current location of the car 3 while they are accessible independent from the distance measurement provided by the laser distance measuring device 33.

Alternatively or additionally, the plausibility may be analyzed while the car 3 is displaced throughout the shaft 5. In such situation, the plausibility information may be derived from acceleration signals provided by the acceleration sensor 29. Based on these signals, a current displacement, velocity and/or acceleration of the car 3 may be determined. These values may then be compared with corresponding values provided based on the distance measurements of the laser distance measuring device 33 in order to analyze the plausibility of these distance measurements.

As a further alternative or addition, the plausibility may be analyzed based on encoder signals provided by the encoder sensor 31. As such encoder signals represent the current orientation of the drive disk 13, they correlate with the current location of the car 3. Such location correlation may be unambiguous in cases where there is no slippage between the suspension traction means 9 and the drive disk 13 and accordingly, the plausibility information may be derived from the encoder signals directly. In other cases where there is slippage between the suspension traction means 9 and the drive disk 13, the encoder signals may nevertheless be used for deriving plausibility information, particularly when information about the distance measured by the laser distance measuring device 33 and information about an encoder signal concurrently output is acquired as forming correlation information and is then stored such that it may be used at a later point in time for comparison with currently acquired correlation information.

As still a further alternative or addition, the plausibility information may be derived from brake signals which determine a current status of a car brake 47 for fixing the car 3 within the shaft 5. Particularly, such brake signals may indirectly provide information about the current location of the car 3, for example in cases where such location has been determined at a preceding point in time and, optionally, corresponding location information has been stored, and it is furthermore known that the car 3 could not move since then due to the car brake 47 having been continuously activated.

Finally, as a further alternative or addition, the plausibility information may be derived from laser quality data which may represent a quality of the laser beam 35 upon being detected in the laser distance measuring device 33 after being reflected at the laser beam reflector 37. For example, a detected light intensity may vary depending on the current location of the car 3 and is, correspondingly, depending on the distance the laser beam 35 has to travel from the laser distance measuring device 33 to the laser beam reflector 37 and back. Furthermore, the detected light intensity will in most cases strongly reduce when for example the laser beam 35 is misaligned and is no more focused onto the laser beam reflector 37 or, upon being reflected at the laser beam reflector 37, no more reaches the light detector in the laser distance measuring device 33. Such light intensity reduction may therefore indicate a loss in plausibility or reliability of measurements provided by the laser distance measuring device 33.

Generally, signals or data may be transmitted between the various sensors and information sources, on the one side, and the controller 15, on the other side, for example using a wireless signal transmission device 41. Alternatively, hardwiring may be established. The signals or data may then be processed in a processing unit 43. Furthermore, the signals or data may be stored in memory 45 before or after the processing thereof.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for determining information about a current location of a car in a shaft of an elevator, the method comprising the steps of:
measuring a distance between a car reference position at the car and a shaft reference position in the shaft using a laser distance measuring device;
analyzing a plausibility of the measured distance taking into account plausibility information correlating with the current location of the car independently from the distance measuring; and
determining the information about the current location of the car based on the measured distance and the analyzed plausibility of the measured distance.

17. The method according to claim 16 including temporarily deactivating the laser distance measuring device and then measuring the distance, and analyzing the plausibility after reactivating the laser distance measuring device.

18. The method according to claim 17 wherein the laser distance measuring device is temporarily deactivated when the car is stopped within the shaft, and wherein the laser distance measuring device is reactivated when the car is started to be displaced within the shaft.

19. The method according to claim 16 including analyzing the plausibility while the car is stopped at a landing, and determining the plausibility information from signals of location sensors that determine a precise location of the car when the car is stopped at the landing.

20. The method according to claim 19 wherein the location sensor is a door sensor provided at one of a car door of the car and a landing door at the landing, the door sensor sensing a presence of a counterpart when the car is positioned at a predetermined location within the shaft.

21. The method according to claim 16 including analyzing the plausibility while the car is displaced throughout the shaft, and wherein the plausibility information is determined from acceleration signals of an acceleration sensor representing an acceleration of the car.

22. The method according to claim 16 including determining the plausibility information from encoder signals of an encoder sensor, the encoder signals representing an orientation of a drive disk of a drive engine displacing the car throughout the shaft.

23. The method according to claim 22 including acquiring correlation information between each of multiple locations of the car throughout the shaft and associated ones of the encoder signals in a learning procedure, and wherein the plausibility information is determined from the encoder signals using the correlation information.

24. The method according to claim 22 wherein, during an operation of the elevator, correlation information including information about the distance between the car reference position and the shaft reference position as measured by the laser distance measuring device and information about a concurrent encoder signal is repeatedly stored in a memory, and wherein the plausibility information is determined by comparing the correlation information currently acquired with a latest preceding one of the stored correlation information read from the memory.

25. The method according to claim 16 wherein the plausibility information is determined from brake signals that represent a current status of a car brake adapted to fix the car within the shaft.

26. The method according to claim 25 wherein, during an operation of the elevator, distance information including information about the distance between the car reference position and the shaft reference position as measured by the laser distance measuring device is stored in a memory before or upon activating the car brake, and wherein, upon detecting that since storing the distance information the car brake was continuously activated fixing the car within the shaft, the plausibility information is determined by comparing the distance information currently acquired with the stored distance information read from the memory.

27. The method according to claim 16 including determining the plausibility information from laser quality data from the laser distance measuring device, the laser quality data representing a quality of a laser beam detected by the laser distance measuring device upon measuring the distance.

28. A method for operating an elevator, the method comprising the steps of:
determining information about a current location of a car of the elevator by performing the method according to claim 16; and
controlling functions of the elevator based on the current location information.

29. A controller for determining information about a current location of a car in a shaft of an elevator, the controller being adapted to at least one of implement and control the method according to claim 16.

30. An elevator comprising:
a shaft;
a car positioned in and displaceable in the shaft;
a laser distance measuring device measuring a distance between a car reference position at the car and a shaft reference position in the shaft; and
a controller according to claim 29.
